(19) United States
(12) Patent Application Publication
(10) Pub. No.: US 2006/0181866 A1
(43) Pub. Date: Aug. 17, 2006

(54) Multi-chip light emitting diode unit, and backlight unit and liquid crystal display device employing the same

(75) Inventors: Il-yong Jung, Suwon-si (KR); Joon-chan Park, Anyang-si (KR); Jong-min Wang, Seongnam-si (KR); Ki-bum Seong, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/295,473

(22) Filed: Dec. 7, 2005

(30) Foreign Application Priority Data
Feb. 16, 2005 (KR) 10-2005-0012902

(51) Int. Cl. G09F 13/04

(52) U.S. Cl. 362/97; 362/231; 362/800; 362/240

(57) ABSTRACT

A multi-chip light emitting diode unit, and a backlight unit and a liquid crystal display device employing the same, are provided. The multi-chip light emitting diode unit includes: a base; a plurality of light emitting elements which are arranged on the base and irradiate at least two wavelengths of light; and a cap which is provided at an upper side of each of the plurality of the light emitting elements, made of a material having a greater refractive index than an adjacent external medium, and which totally internally reflects the light emitted from the light emitting elements.

### CROSS-REFERENCE TO RELATED PATENT APPLICATION

This application claims priority from Korean Patent Application No. 10-2005-0012902, filed on Feb. 16, 2005, in the Korean Intellectual Property Office, the disclosure of which is incorporated herein in its entirety by reference.

### BACKGROUND OF THE INVENTION

1. Field of the Invention

The present invention relates to a multi-chip light emitting diode unit, and a backlight unit and a liquid crystal display device employing the same and, more particularly, to a multi-chip light emitting diode unit, and a backlight unit and a liquid crystal display device employing the same, which can be slimmed by reducing the distance between a light source and a diffusing plate.

2. Description of the Related Art

Generally, a liquid crystal display device is a flat panel display device used in a notebook computer, a desktop computer, an LCD-TV, or a mobile communication terminal which is a kind of a photodetector and has a backlight unit in addition to a liquid crystal panel. The liquid crystal display (LCD) device does not emit the light itself to form the image. That is, since the liquid crystal display device is the light receiving element which receives the light from outside to form the image, it requires the backlight unit. The backlight unit is provided on the rear surface of the liquid crystal display device.

Backlight units generally are classified into two types: the direct light type, for irradiating the light from a plurality of light sources provided under the liquid crystal panel, and the edge light type, for irradiating the light from a light source provided on the side of a light guide panel (LGP) behind the liquid crystal panel. The edge light type backlight unit usually uses a cold cathode fluorescent lamp (CCFL). However, since the cold cathode fluorescent lamp has a low color gamut, it is not suitable for a high-definition, high-resolution TV or monitor. Recently, light emitting diodes (LEDs) have become an attractive substitute for the CCFL. For example, the direct light type backlight unit uses a light emitting diode for emitting the Lambertian light as a point light source.

As shown in FIG. 1, a conventional backlight unit includes an LED 500, and a diffusing plate 503 and a diffusing sheet 505 for uniformly inputting the light emitted from the LED 500 to a liquid crystal panel 510. A reflecting plate 502 for reflecting the light emitted from the LED 500 onto the liquid crystal panel 510 is provided at the lower side of the LED 500. A prism sheet 507 for correcting an optical path to direct the light to the liquid crystal panel 510 is placed between the diffusing sheet 505 and the diffusing plate 503.

In order to mix the light from the LED 500 to make white light, a space between the LED 500 and the diffusing plate 503 is needed. If the distance D between the LED and the diffusing plate is large, the backlight unit is thick. If the distance is small, the backlight unit is thin, but the light emitted from the LED is not mixed well, and hot spots appear when viewing the backlight unit from the front, which degrade the image quality.

If the backlight unit is thick, the liquid crystal display device such as an LCD or TV is also thick.

### SUMMARY OF THE INVENTION

The present invention provides a multi-chip light emitting diode unit which is formed such that the lights are mixed in a package.

The present invention also provides a backlight unit and a liquid crystal display device, which can be slimmed by reducing the distance required for mixing the light irradiated from a light source.

According to an aspect of the present invention, there is provided a multi-chip light emitting diode unit including: a base; a plurality of light emitting elements which are arranged on the base and irradiate at least two wavelengths of light; and a cap which is provided at an upper side of each of the plurality of the light emitting elements, made of a material having a greater refractive index than an adjacent external medium, and which totally internally reflects the light emitted from the light emitting elements.

The plurality of the light emitting elements may be arranged at the periphery of the base.

The cap may be formed in at least one of a cone, many-sided cone or dome shape.

The cap may be composed of a lens.

The plurality of light emitting elements may include a first light emitting element for irradiating red light, a second light emitting element for irradiating green light and a third light emitting element for irradiating blue light.

According to another aspect of the present invention, there is provided a backlight unit including: a reflecting plate which reflects incident light; a plurality of multi-chip light emitting diode units which are provided on the reflecting plate and include a base, a plurality of light emitting elements which are arranged on the base and irradiate at least two wavelengths of light, and a cap which is provided at an upper side of each of the plurality of the light emitting elements, made of a material having a greater refractive index than an adjacent external medium, and totally internally reflects the light emitted from the light emitting elements; and a diffusing plate which is located at an upper side of the multi-chip light emitting diode units and diffuses and transmits the incident light.

According to another aspect of the present invention, there is provided a liquid crystal display device including the backlight unit; and a liquid crystal panel which forms an image using the light irradiated from the backlight unit.

### BRIEF DESCRIPTION OF THE DRAWINGS

The above and other features and advantages of the present invention will become more apparent by describing in detail exemplary embodiments thereof with reference to the attached drawings, in which:

FIG. 1 shows a conventional direct light type backlight unit employed in a liquid crystal display device;

FIG. 2 is a schematic cross-sectional view of a backlight unit according to an exemplary embodiment of the present invention;

FIG. 3 shows a multi-chip light emitting diode unit according to the present invention located on a reflecting plate;

FIG. 4A is a perspective view of a multi-chip light emitting diode unit according to a first embodiment of the present invention;

FIG. 4B is a cross-sectional view of the multi-chip light emitting diode unit shown in FIG. 4A;

FIG. 5 shows a light reflecting path in a cone-shaped cap employed in the multi-chip light emitting diode unit according to the first embodiment of the present invention;

FIG. 6A is a cross-sectional view of the multi-chip light emitting diode unit according to a second embodiment of the present invention;

FIG. 6B is a perspective view of the multi-chip light emitting diode unit according to a third embodiment of the present invention;

FIG. 7 shows light intensity versus angle of radiation for a backlight unit employing the multi-chip light emitting diode unit according to the first embodiment of the present invention;

FIG. 8 shows light intensity versus angle of radiation for a backlight unit employing the multi-chip light emitting diode unit according to the second embodiment of the present invention;

FIG. 9 shows hot spot measurements for the backlight unit employing the multi-chip light emitting diode unit according to the first embodiment of the present invention;

FIG. 10 shows hot spot measurements for the backlight unit employing the multi-chip light emitting diode unit according to the second embodiment of the present invention; and

FIG. 11 schematically shows a liquid crystal display device according to the present invention.

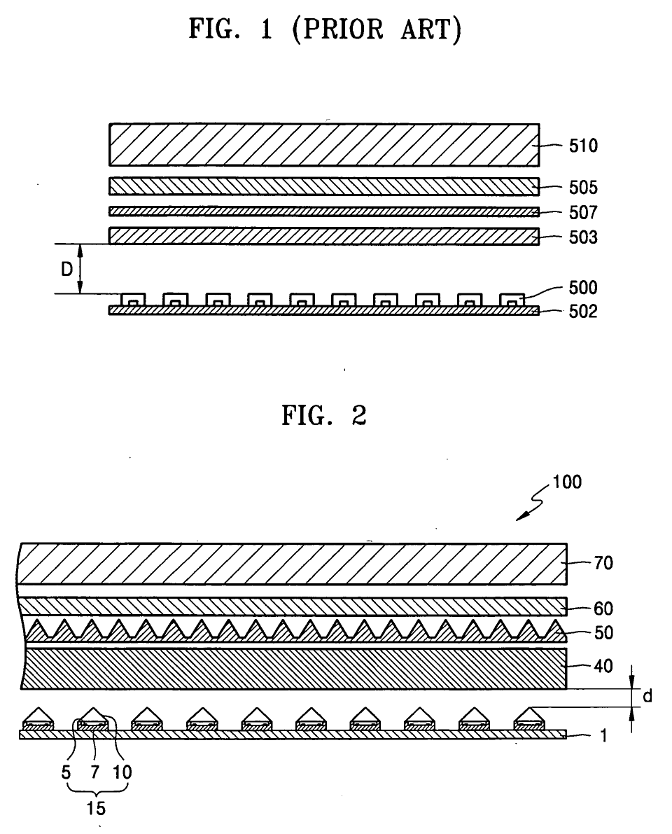

### DETAILED DESCRIPTION OF THE INVENTION

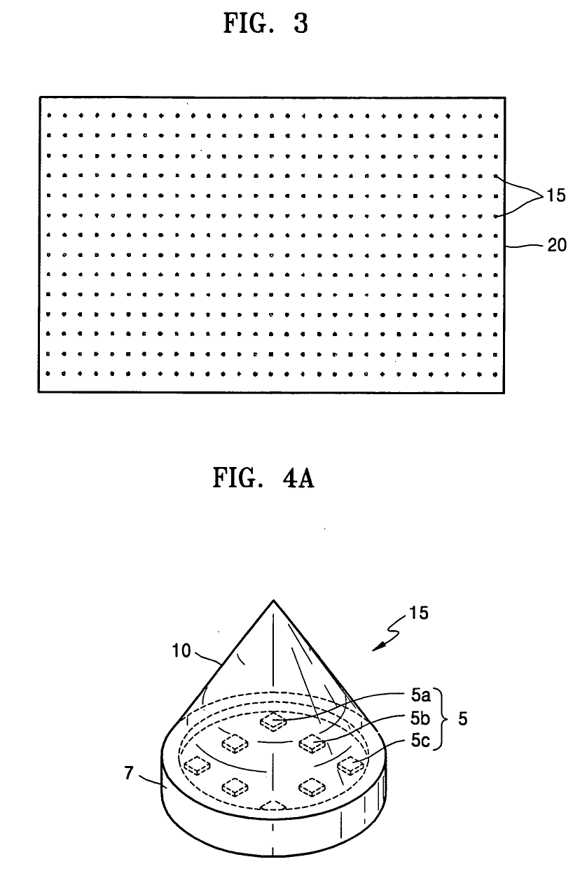

Referring to FIG. 2, a backlight unit 100 according to an exemplary embodiment of the present invention includes a reflecting plate 1, a plurality of multi-chip light emitting diode units 15 arranged on the reflecting plate 1, and a diffusing plate 40. As shown in FIG. 3, the plurality of multi-chip light emitting diode units 15 are two-dimensionally arranged on the reflecting plate 1.

The multi-chip light emitting diode unit 15 according to the present invention includes a plurality of light emitting elements for irradiating at least two wavelengths of light and a cap for obtaining total internal reflection of the light from the light emitting diodes. The different wavelengths of light from the light emitting elements are totally internally reflected several times and are mixed in the light emitting diode unit.

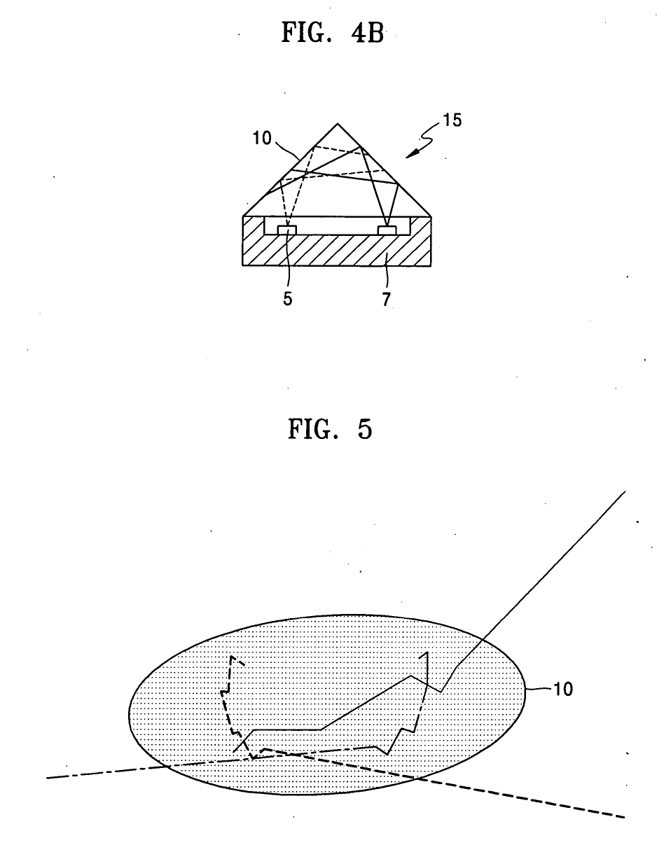

The multi-chip light emitting diode unit according to a first embodiment is shown in FIGS. 4A and 4B. In the light emitting diode unit 15, a plurality of light emitting elements 5 are arranged on a base 7, and a cap 10 is provided at the upper side of each of the plurality of light emitting elements 5.

The light emitting elements 5 emit at least two different wavelengths of light. For example, the light emitting elements 5 may include a first light emitting element 5a for emitting red light, a second light emitting element 5b for emitting green light, and a third light emitting element 5c for emitting blue light. In FIG. 4A, eight light emitting elements are shown, including three first light emitting elements 5a, two second light emitting elements 5b, and three third light emitting elements 5c. The number or arrangement of the light emitting elements for each wavelength can be selected according to the desired color temperature range, in consideration of the amount of light emitted from the light emitting element for each wavelength. In the present invention, since the light emitting diode unit can be set by various numbers and arrangements of the light emitting elements for emitting the multi-wavelength lights, the color exhibition is good and the color selectivity is large for purposes of manufacturing. Also, the multi-chip light emitting diode unit according to the present invention is of similar size to a single-chip light emitting diode unit.

The light emitted from the light emitting elements is totally internally reflected several times and mixed in the cap 10. The cap 10 is made of transparent material, for example, a lens. The material of the cap 10 has a greater refractive index than the medium between the light emitting diode unit 15 and the diffusing plate 40, in order to satisfy the total reflection condition. For example, if the medium between the light emitting diode unit 15 and the diffusing plate 40 is air, the cap may be made of epoxy resin or polymethylmethacylate (PMMA), with a refractive index of 1.49. Since the cap 10 has a greater refractive index than air, light input at an angle greater than a threshold angle θ_{C} is totally internally reflected several times before leaving the cap 10. Thereby, the light from the light emitting elements is mixed in the cap, and white light is emitted. Since the different wavelengths of light are mixed in the cap 10 and emitted from the light emitting diode unit 15 toward the diffusing plate 40, the light need not be mixed between the light emitting diode unit 15 and the diffusing plate 40. Accordingly, the distance d (see FIG. 2) between the light emitting diode unit 15 and the diffusing plate 40 can be decreased.

The cap 10 may be in a cone, dome or pyramid shape. The cone-shaped cap 10 is shown in FIGS. 4A and 4B.

It is preferable, but not necessary, that the light emitting elements 5a, 5b and 5c are arranged at the periphery of the base 7, not in the center of the base 7. If the light emitting elements are not arranged in the center of the base 7, hot spots can be prevented. Hot spots are partially brightly viewed when the light from the light emitting elements is not uniformly diffused, and degrade the image quality. If the light emitting elements are located in the center of the base, most of the light exits through the vertex of the cap 10, instead of being totally internally reflected, because it strikes the surface of the cap 10 at less than the threshold angle θ_{C}. If the light emitting elements are arranged at the periphery of the base 7, most of the light from the light emitting elements strikes the cap 10 at greater than the threshold angle θ_{C}, and is totally internally reflected.

FIG. 5 shows the tracking of the light beam at the surface of the cone-shaped cap 10, and shows the light which is totally internally reflected several times before exiting.

The reflecting plate 1 enhances the light efficiency by reflecting the light toward the diffusing plate 40 when a portion of the light from the light emitting diode unit 15 is emitted to the reflecting plate 1.

The white light emitted from the light emitting diode unit 15 is diffused by the diffusing plate 40. A prism sheet 50 for correcting the optical path is provided at the upper side of the diffusing plate 40. Also, a brightness enhancement film (BEF) 60 for enhancing the directionness of the light emitted from the diffusing plate 40, and a polarization enhancement film 70 for enhancing the polarization efficiency, may be further provided at the upper side of the prism sheet 50. The brightness enhancement film 60 enhances the brightness by refracting and focusing the light emitted from the diffusing plate 40 to increase the directionness of the light.

For example, the polarization enhancing film 70 transmits P-polarization light and reflects S-polarization light.

As mentioned above, since the light emitting diode unit according to the present invention includes a plurality of light emitting elements for irradiating the multi-wavelength lights and the cap for totally internally reflecting and mixing the light emitted from the light emitting elements, the space for mixing the light emitted from the light emitting diode unit can be greatly reduced. Thereby, the space or distance d (see FIG. 2) between the light emitting diode unit 15 and the diffusing plate 40 can be greatly reduced and the overall thickness of the backlight unit can be reduced.

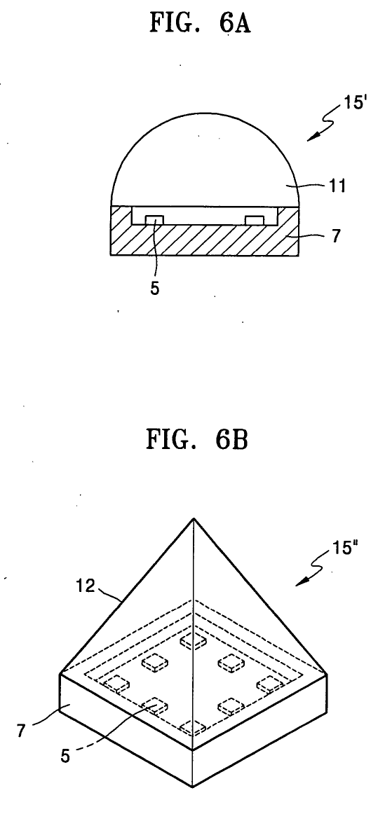

The light emitting diode unit 15′ is constructed as shown in FIG. 6A. The light emitting diode unit 15′ according to a second embodiment includes light emitting elements 5 which are arranged on a base 7 and emit at least two wavelengths of light, and a dome-shaped cap 11 at the upper side of the light emitting elements 5. In the light emitting diode unit 15′ according to the second embodiment, it is preferable, but not necessary, that the light emitting elements 5 are arranged at the periphery of the base 7, not in its center.

The different wavelengths of light irradiated from the light emitting elements 5 are totally internally reflected several times and mixed in the cap 11, and then emitted to the outside of the cap 11.

In the light emitting diode unit 15″ according to a third embodiment, a cap 12 is formed in a pyramid shape, for example, a quadrangular shape.

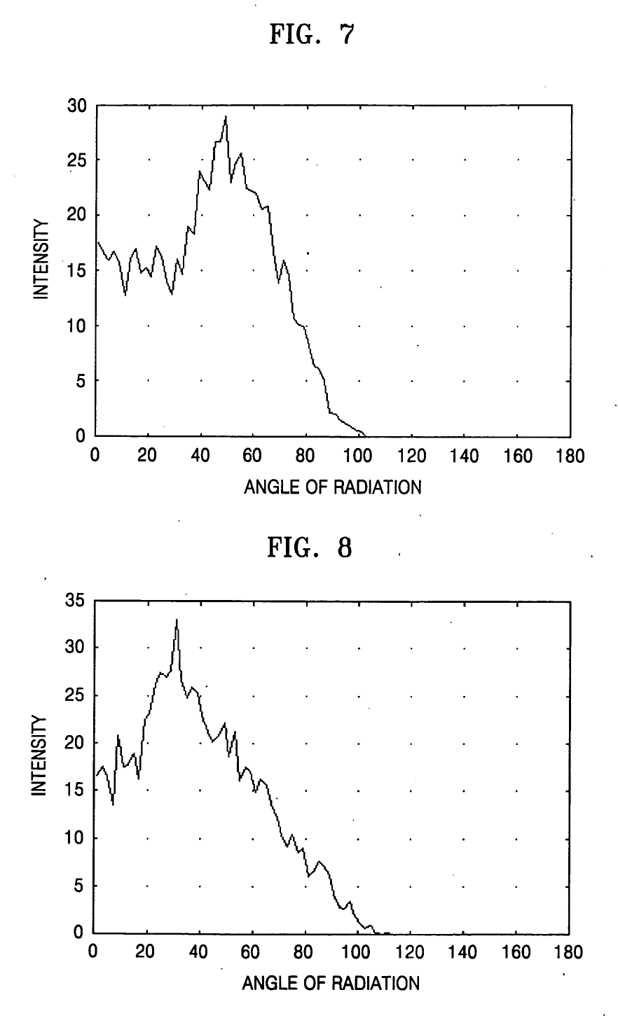

FIG. 7 shows light intensity versus angle of radiation for the light emitting diode unit having the cone-shaped cap 10, and shows that most light is emitted in the range of about 50˜60°.

FIG. 8 shows light intensity versus angle of radiation for the light emitting diode unit having the dome-shaped cap 11, and shows that most light is emitted in the range of about 30˜40°.

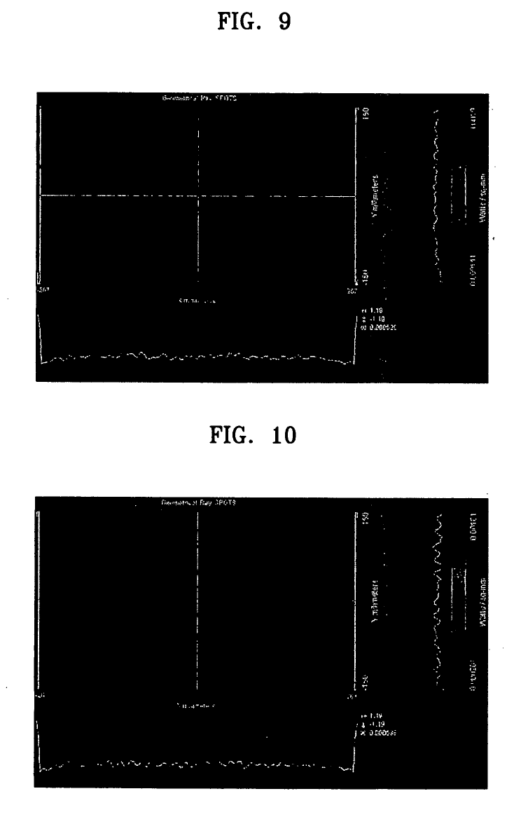

According to this result, the intensity of the light emitted from the vicinity of 0° in the front surface of the light emitting diode unit according to the present invention is relatively small. Accordingly, hot spots can be prevented by applying the light emitting diode unit according to the present invention to the direct light type backlight unit. FIG. 9 shows the result of simulating the light emitted from the backlight unit employing the light emitting diode unit having the cone-shaped cap, and FIG. 10 shows the result of simulating the light emitted from the backlight unit employing the light emitting diode unit having the dome-shaped cap. Comparing FIG. 9 with FIG. 10, the cone-shaped cap is better than the dome-shaped cap at preventing hot spots. However, the backlight unit having the dome-shaped cap is still much better at preventing hot spots than the conventional backlight unit.

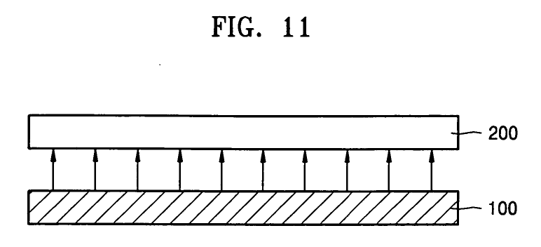

FIG. 11 schematically shows a liquid crystal display device including the backlight unit having the light emitting diode unit 15 according to the present invention. The liquid crystal display device according to the present invention includes a backlight unit 100 and a liquid crystal panel 200 which is provided on the backlight unit 100 and forms an image. The backlight unit 100 employs the multi-chip light emitting diode unit 15, 15′ or 15″.

The liquid crystal panel 200 includes a thin film transistor and an electrode as a pixel unit, and displays the image by applying an electric field to a liquid crystal. Since the concrete structure of the liquid crystal panel and the image display operation according to circuit driving in the liquid crystal display device are widely known, their description will be omitted.

As mentioned above, the multi-chip light emitting diode unit according to the present invention includes a plurality of light emitting elements for irradiating at least two different wavelengths of light, and totally internally reflects and mixes the light emitted from the light emitting elements several times before the light exits. Thereby, the space for mixing the light outside the light emitting diode unit can be greatly reduced. Accordingly, the thickness of the backlight unit and the liquid crystal display device can be greatly reduced.

Also, since most light is emitted from the side of the light emitting diode unit, hot spots can be prevented and the image quality can be increased.

Further, the number of light emitting elements for emitting different colored light, or the arrangement of the light emitting elements, can be easily adjusted, compared with a single-chip light emitting diode unit, and thus the color gamut can be greatly increased to ensure a natural image quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-chip light emitting diode unit comprising:
a base;
a plurality of light emitting elements which are arranged on the base and irradiate at least two wavelengths of light; and
a cap which is provided at an upper side of each of the plurality of light emitting elements, made of a material having a greater refractive index than an adjacent external medium, and which totally internally reflects the light emitted from the light emitting elements.

2. The multi-chip light emitting diode unit according to claim 1, wherein the plurality of light emitting elements are arranged at a periphery of the base.

3. The multi-chip light emitting diode unit according to claim 1, wherein the cap is formed in at least one of a cone, pyramid or dome shape.

4. The multi-chip light emitting diode unit according to claim 1, wherein the cap is composed of a lens.

5. The multi-chip light emitting diode unit according to claim 3, wherein the cap is composed of a lens.

6. The multi-chip light emitting diode unit according to claim 1, wherein the plurality of light emitting elements include a first light emitting element for irradiating red light, a second light emitting element for irradiating green light and a third light emitting element for irradiating blue light.

7. A backlight unit comprising:
a reflecting plate which reflects incident light;
a plurality of multi-chip light emitting diode units which are provided on the reflecting plate and include a base, a plurality of light emitting elements which are arranged on the base and irradiate at least two wavelengths of light, and a cap which is provided at an upper side of each of the plurality of light emitting elements, made of a material having a greater refractive index than an adjacent external medium, and which totally internally reflects the light emitted from the light emitting elements; and
a diffusing plate which is located at an upper side of the multi-chip light emitting diode units and diffuses and transmits the incident light.

8. The backlight unit according to claim 7, wherein the plurality of light emitting elements are arranged at a periphery of the base.

9. The backlight unit according to claim 7, wherein the cap is formed in at least one of a cone, many-sided cone or dome shape.

10. The backlight unit according to claim 7, wherein the cap is composed of a lens.

11. The backlight unit according to claim 9, wherein the cap is composed of a lens.

12. The backlight unit according to claim 7, wherein the plurality of light emitting elements include a first light emitting element for irradiating red light, a second light emitting element for irradiating green light and a third light emitting element for irradiating blue light.

13. A liquid crystal display device comprising:
the backlight unit according to claim 7; and
a liquid crystal panel which forms an image using light irradiated from the backlight unit.

14. A liquid crystal display device comprising:
the backlight unit according to claim 8; and
a liquid crystal panel which forms an image using light irradiated from the backlight unit.
